(19) United States
(12) Patent Application Publication
(10) Pub. No.: US 2011/0122221 A1
(43) Pub. Date: May 26, 2011

(54) SERVO CONTROL DEVICE AND METHOD FOR REMOTE SURVEILLANCE AND MONITORING

(75) Inventors: Chun-Hsu Su, Taipei City (TW); Ren-Peng Chen, Taipei (TW)

(73) Assignee: AMROAD TECHNOLOGY, INC., Taipei County (TW)

(21) Appl. No.: 12/624,408

(22) Filed: Nov. 24, 2009

(51) Int. Cl. H04N 7/14

(52) U.S. Cl. 348/14.04; 348/E07.078

(57) ABSTRACT

The present invention relates to a servo control device and method for remote surveillance and monitoring. The servo control device at least comprises an internet interface processing unit, an internet phone processing unit, an external device management unit, a wireless RF unit, a storage unit and a power unit. The method of the servo control device includes that the internet phone processing unit verifies if the phone number and password of the external communication device is correct; if YES, the external communication device enters a command; if the external communication device enters a change command, the servo control device change the status of at least an external device and the changed status information is stored in the storage unit; in addition, the internet phone processing unit transforms the status information to a image file and the image file is sent back to the external communication device.

### BACKGROUND OF THE INVENTION

1. Field of the Invention

The present invention generally relates to a servo control device and method for remote surveillance and monitoring, more particularly, a servo control device receives messages from an external communication device through an internet interface and carries out the change in the status of at least a specific external device through an internet phone processing unit, an external device management unit, a wireless RF unit, an I/O unit and a storage unit, and then, the changed status information is sent back to the external communication device.

2. Description of the Prior Art

Science and technology have been rapidly progressed in recent years, especially in the fields of cellular phone and broadband network, so as to gradually change the way of modern life; the combination of web communication and information appliances (IA) has become the tendency toward future human life by means of video technology and smart life. The World Health Organization (WHO) once suggested that safety, sanitation, convenience and comfort are four basic requirements of a safe, healthy, accessible and pleasant community life. Nowadays, intelligent and smart appliances have met the safety, sanitation, energy saving, convenience and comfort requirements of human life.

Surveillance and monitoring systems of prior arts generally employ manpower in another space to keep surveillance through and apply VHS video tapes to stored videos, most of those tapes are used with repetition, so that the stored data are to be replaced with new data in a week or in a month, in addition, most of the surveillance and monitoring systems of prior arts are unable to spontaneously provide real-time detection, nor proceed monitoring through internet navigation.

In recent years, internet and communication technology has been integrated to function not only spontaneous monitoring on a single dwelling house or a specific location, but also interactive remote controlling on specific appliances. When a user leaves his/her dwelling house, the user is able to remote control household electrical appliances, such as to activate a home video recorder to pre-record TV programs or to remotely switch off the power of an electric pot, a heater, an air conditioner, an electric fan or a cooking device, if people are out of home; moreover, people are able to remotely control an air conditioner to adjust the room temperature before they get home.

As telephone networks have been broadly established, telephone sets are prerequisite household communication devices, therefore, most of the conventional technologies for remote control of household electrical appliances apply telephone lines to enable users to input number keys to control household electrical appliances, namely, conventional technologies of remote control over household electrical appliances are proceeded through telephone lines. Nevertheless, conventional technologies of remote control over household electrical appliances apply voice messages to announce relevant information and a user follows the voice instructions to enter numbers for executing remote control; when the user is in a noisy environment or the voice instructions are not clear, the user would have trouble in processing remote control over a specific household electrical appliance.

In addition, some technologies apply a personal computer and internet to carry out remote control over a specific household electrical appliance; nevertheless, such method requires a user to possess a portable personal computer or the user must be in a location with public internet access available, otherwise, it is inconvenient for a user to apply such method to perform remote control function.

Seeing that most of developed portable communication devices in recent years have embedded with internet access function, a user can apply his/her portable communication device to perform remote control function over a specific household electrical appliance through internet access. Nevertheless, such method requires a user to have a specific type of portable communication device with special software or firmware installed in the portable communication device; otherwise, such method is not applicable.

In view of the foregoing, Taiwan (ROC) Patent No. 1293838 of method and device for remote controlling on household electrical appliances is disclosed, enabling a calling party to send a message (e.g. SMS) to a called party for remote control over specific household electrical appliances near the location of the called party based on one or multiple pre-set authorized telephone numbers and one or multiple household electrical appliance numbers.

To enable successful remote control over specific household electrical appliances, a PHS wireless interface module must be installed on each of the household electrical appliances, and then the method enables the PHS network to send a message between the called party and a targeted household electrical appliance for remote control over the targeted household electrical appliance. However, if there are a lot of household electrical appliances to be controlled remotely, the same amount of PHS wireless interface modules are required for installation. Such method would cost a lot.

In said invention, after the calling party has proceeded remote controls on a household electrical appliance, the called party is incapable of sending information back to the calling party, therefore, the calling party is unable to instantly know the status of the household electrical appliance. Provided that there is any error or controlling failure during the remote control processing, such remote control is meaningless as the calling party in unable to know the status immediately.

### SUMMARY OF THE INVENTION

In view of the aforementioned disadvantages and problems of the prior art, the inventor of the present invention, relying on his years of experience, fully implemented his imagination and creativeness, to repeatedly experiment and make modification, and eventually developed a servo control device and method for remote surveillance and monitoring.

the primary objective of the present invention is to provide a servo control device and method for remote surveillance and monitoring, wherein the servo control device comprises an internet phone processing unit, which retrieves the status information of a specific external device from a storage unit, the status information of the specific external device is transformed into an image file to be sent to an external communication device. Seeing that various video communication devices have been popularized and available, any person is able to remote control an electrical appliance or device through remote video monitoring, which improves the disadvantage of applying conventional voice way.

Another objective of the present invention is to provide a servo control device and method for remote surveillance and monitoring, enabling a portable video phone or other video phone, which is able to connect to internet, to easily achieve the goal of remote surveillance and monitoring, instead of using a personal computer to proceed remote monitoring through web.

Another objective of the present invention is to provide a servo control device and method for remote surveillance and monitoring, enabling the internet phone processing unit to retrieve a command list from the storage unit, transform the command list into an image file, and transmit the image file to the external communication device. As long as the external communication device is a kind of video communication device, the image file is able to be opened, and then a user is able to follow the command list of the image to input a command for remote monitoring and controlling. The method does not require a user to carry a specific type of a portable communication device, nor install any special software or firmware. Therefore, the method of the present invention is more flexible and convenient for a variety of users.

Another objective of the present invention is to provide a servo control device and method for remote surveillance and monitoring, when an external device to be remotely controlled is able to optionally install a wireless RF unit or an I/O unit inside, so that the servo control device applies the wireless RF unit and the I/O unit to proceed remote controlling and monitoring, moreover, said external device is able to install both of a wireless RF unit and an I/O unit to increase diversified operations.

Another objective of the present invention is to provide a servo control device and method for remote surveillance and monitoring, when the status of an external device is changed, the status information is then stored in the storage unit, subsequently, the internet phone processing unit retrieves the status information of the specific external device from the storage unit, transforms the status information of the external device into an image file and transmits the image file back to the external communication device through an internet interface; therefore, the present invention enables a user to immediately receive all relevant information without any delay or returning back to home.

Another objective of the present invention is to provide a servo control device and method for remote surveillance and monitoring, when the internet phone processing unit of the servo control device receives a telephone message from an external communication device, the internet phone processing unit verifies if the telephone message is correct, if YES, requests a password to be inputted from the external communication device, verifies if the password entered from the external communication device is correct, if YES, the present invention proceeds remote surveillance and monitoring. Owing to the dual verification mechanism, the present invention enables more secure remote surveillance and monitoring.

Another objective of the present invention is to provide a servo control device and method for remote surveillance and monitoring, when there is any change in the status of an external device, all changed status information are stored in the storage unit, therefore, when a user wants to search the status information of the external device only, the present invention does not apply the external device management unit, a wireless RF unit and/or an I/O unit to execute commands, instead, the internet phone processing unit directly retrieves such data from the storage unit, in order to save time in activating the device.

To achieve the aforementioned objectives, the invention provides a servo control device and method for remote surveillance and monitoring. The servo control device at least comprises (1) an internet interface processing unit which provides an internet interface by a telecommunication carrier/services provider, enabling an external communication device to receive and send web messages; (2) an internet phone processing unit for receiving messages from the external communication device through the internet interface processing unit, sending messages to the external communication device, verifying telephone messages of the external communication device, and transforming data to either a text file or an image file; (3) an external device management unit, which receives a command from the internet phone processing unit and sends messages to the internet phone processing unit; (4) a wireless RF unit, which connects with the external device management unit, receives a command from the external device management unit, controls the status of at least an external device by means of wireless RF, sends the status information of the external device back to the external device management unit; (5) a storage unit, which stores the status information of the external device, connects with the internet phone processing unit, enabling the internet phone processing unit to send a command to the storage unit, and sends the status information of the external device to the internet phone processing unit; and (6) a power unit, providing electric power to activate the servo control device.

The invention further provides a control method to a servo control device for remote surveillance and monitoring, wherein the control method further comprising the following steps: (1) the servo control device receives a telephone message from an external communication device through an internet interface processing unit; (2) the internet phone processing unit verifies if the telephone message is correct, if YES, the step goes to step (3); (3) the internet phone processing unit requests the user to input a command from the external communication device; (4) if the internet phone processing unit receives an inquiry command, the step goes to step (5); if the internet phone processing unit receives a change command, the step goes to step (6); (5) the internet phone processing unit retrieves the status information of the specific external device from the storage unit, and then the step goes to step (10); (6) the internet phone processing unit transmits the change command to the external device management unit; (7) the external device management unit transmits the change command to the wireless RF unit; (8) the wireless RF unit changes the status of at least an external device based on the change command received; (9) the status information of the external device after being changed is stored in the storage unit; (10) the internet phone processing unit transforms the status information of the external device into an image file; and (11) the internet phone processing unit transmits the image file back to the external communication device.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a system structure showing of a preferred embodiment of a servo control device for remote surveillance and monitoring of the present invention;

FIGS. 2A & 2B illustrate a control method of the servo control device for remote surveillance and monitoring based on the preferred embodiment of the present invention;

FIG. 3 illustrates a flow chart showing the steps of determining the telephone message based on the preferred embodiment of the present invention; and

FIG. 4 illustrates a flow chart showing the steps of requesting to enter a command based on the preferred embodiment of the present invention.

### DETAILED DESCRIPTION OF THE INVENTION

To achieve the foregoing objectives and effects, the inventor of the present invention integrates an extensively applicable method for remote surveillance and monitoring and develops a servo control device, so as to excogitate a servo control device and method for remote surveillance and monitoring. Hereinafter, a preferred embodiment of the servo control device and method for remote surveillance and monitoring of the present invention will be described in detail so as to illustrate the structural and technical features of the present invention.

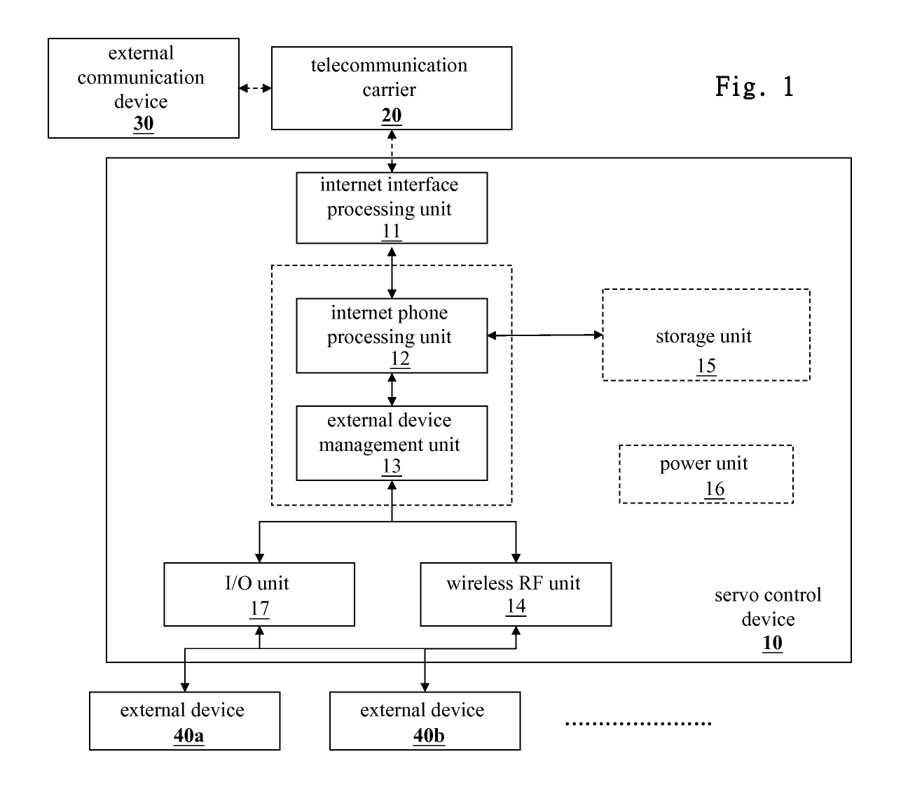

FIG. 1 is a system structure showing of a preferred embodiment of a servo control device for remote surveillance and monitoring of the present invention. The servo control device 10 is installed in a dwelling house or an office location. The servo control device 10 at least comprises (1) an internet interface processing unit 11, which provides an internet interface by a telecommunication carrier/services provider 20, enabling an external communication device 30 to receive and send web messages; (2) an internet phone processing unit 12 for receiving messages from the external communication device 30 through the internet interface processing unit 11, sending messages to the external communication device 30, verifying telephone messages of the external communication device 30, and transforming data to either a text file or an image file; (3) an external device management unit 13, which receives a command from the internet phone processing unit 12 and sends messages to the internet phone processing unit 12; (4) a wireless RF unit 14, which connects with the external device management unit 13, receives a command from the external device management unit 13, controls the statuses of external devices 40a and 40b by means of wireless RF, sends the status information of the external devices 40a and 40b back to the external device management unit 13; (5) a storage unit 15, which stores the status information of the external devices 40a and 40b, connects with the internet phone processing unit 12 enabling the internet phone processing unit 12 to send a command to the storage unit 15, and sends the status information of the external devices 40a and 40b to the internet phone processing unit 12; and (6) a power unit 16, supplying electric power by either a battery, Alternating current (AC) or a universal serial bus (USB) to activate the servo control device 10.

The external communication device 30 is either a portable video phone, a personal digital assistant (PDA), an in-car video communication device, an office video phone or a home video phone. The external devices 40a and 40b are either a kind of electronic product, a robot or a security device. In FIG. 1, the preferred embodiment only displays two external devices 40a and 40b; nevertheless, pluralities of external devices are applicable for connection at the same time.

Moreover, the servo control device 10 further comprises an I/O unit 17, which connects with the external device management unit 13, receives a command from the external device management unit 13, controls the status of the external devices 40a and 40b, through wire lines and sends the status information of the external devices 40a and 40b and sends the status information back to the external device management unit 13. Therefore, the servo control device 10 of the present invention enables the wireless RF unit 14 and the I/O unit 17 to control the external devices 40a and 40b; in addition, applies both of the wireless RF unit 14 and the I/O unit 17 to control only an external device, such as the external device 40a.

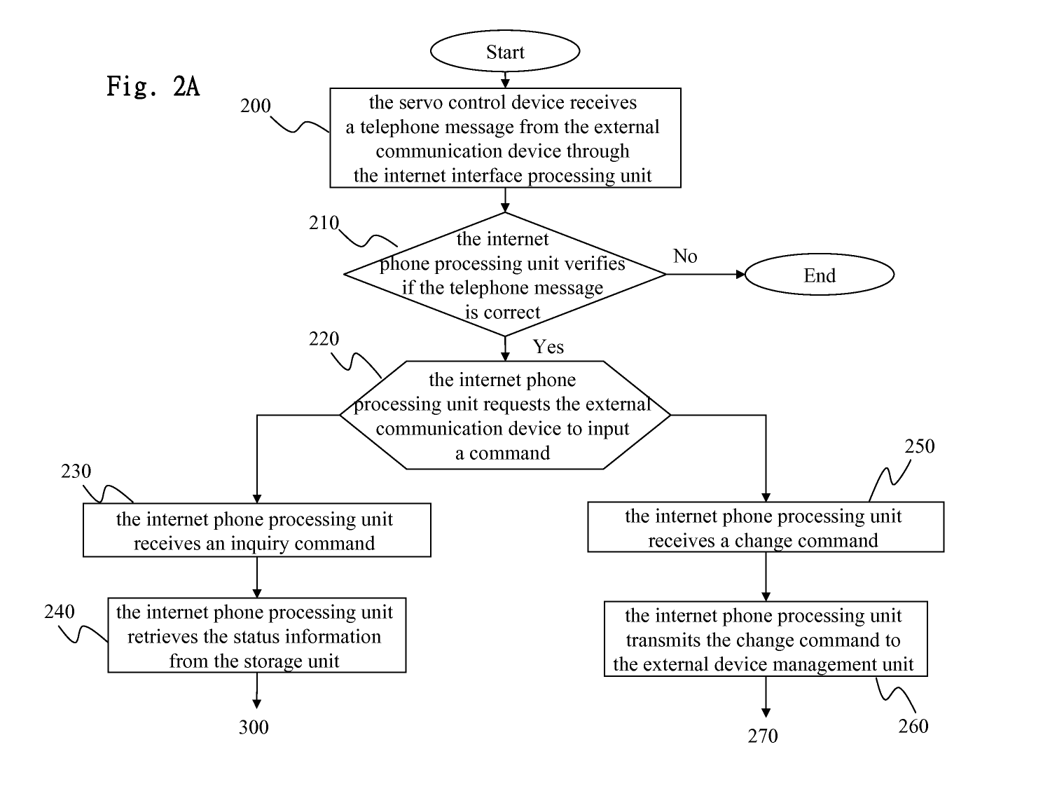

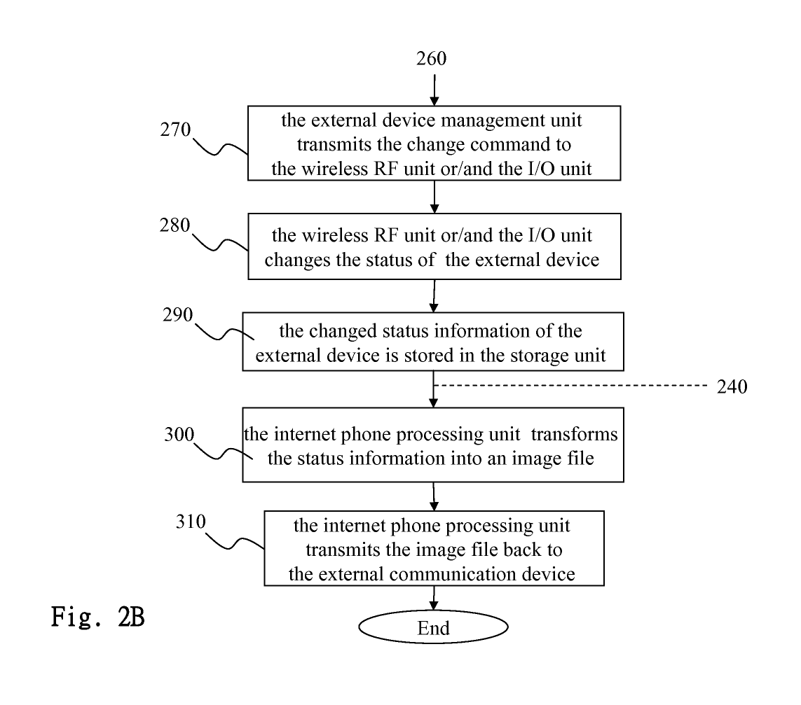

FIGS. 2A & 2B illustrate a control method of the servo control device for remote surveillance and monitoring based on the preferred embodiment of the present invention. The method comprises the following steps: (step 200) the servo control device 10 receives a telephone message from the external communication device 30 through the internet interface processing unit 11; (step 210) the internet phone processing unit 12 verifies if the telephone message is correct, if YES, goes to step 220, otherwise, finishes the all steps; (step 220) the internet phone processing unit 12 requests the external communication device 30 to input a command; (step 230) the internet phone processing unit 12 receives an inquiry command; (step 240) the internet phone processing unit 12 retrieves the status information of the specific external devices 40a and 40b from the storage unit 15; (step 300) the internet phone processing unit 12 transforms the status information of the external devices 40a and 40b into an image file; (step 310) the internet phone processing unit 12 transmits the image file back to the external communication device 30; (step 250) the internet phone processing unit 12 receives a change command; (step 260) the internet phone processing unit 12 transmits the change command to the external device management unit 13; (step 270) the external device management unit 13 transmits the change command to the wireless RF unit 14 or/and the I/O unit 17; (step 280) the wireless RF unit 14 or/and the I/O unit 17 changes the status of at least one of the external devices 40a and 40b based on the change command received; (step 290) the status information of the external devices 40a and/or 40b after being changed is stored in the storage unit 15; (step 300) the internet phone processing unit 12 transforms the status information of the external devices 40a and 40b into an image file; (step 310) the internet phone processing unit 12 transmits the image file back to the external communication device 30.

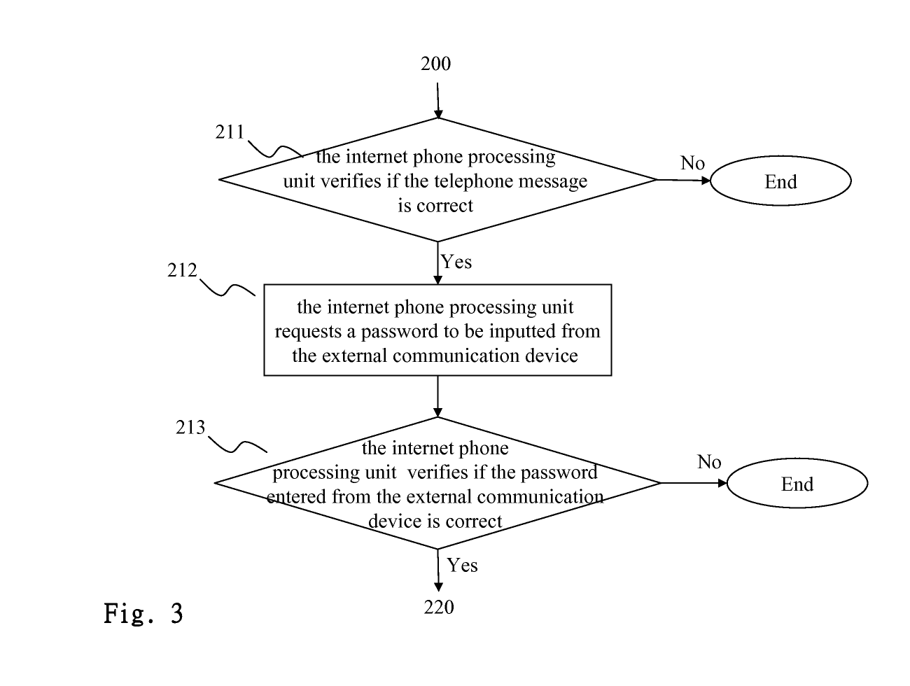

In the method of the present invention described above, step 210 (the internet phone processing unit 12 verifies if the telephone message is correct) further comprises the following steps as shown in FIG. 3 that (step 211) the internet phone processing unit 12 receives a telephone message and verifies if the telephone message is correct; (step 212) if the telephone number is correct, the internet phone processing unit 12 requests a password to be inputted from the external communication device 30; (step 213) the internet phone processing unit 12 verifies if the password entered from the external communication device 30 is correct; if YES, the step goes to step 220. During the processing, if the telephone message or the password inputted from the external communication device 30 is incorrect, the process is then ended.

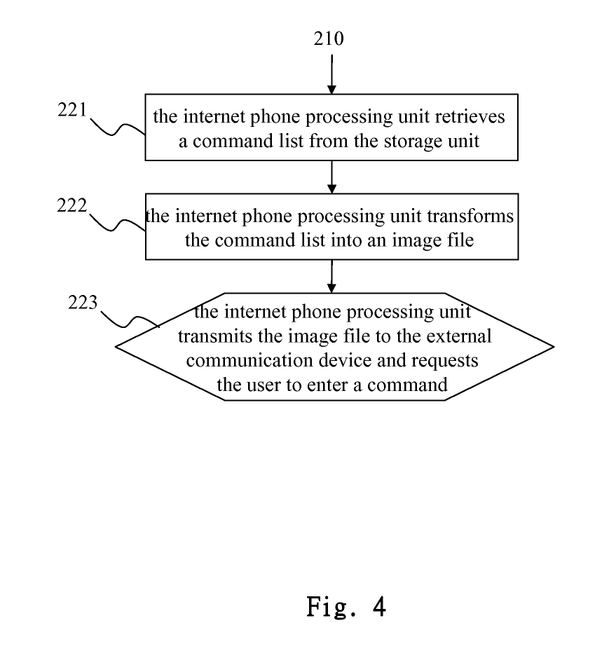

In addition, in the preferred embodiment of the present invention, step 220 (the internet phone processing unit 12 requests the external communication device 30 to input a command) further comprises the following steps as shown in FIG. 4 that (step 221) the internet phone processing unit 12 retrieves a command list from the storage unit 15; (step 222) the internet phone processing unit 12 transforms the command list into an image file; (step 223) the internet phone processing unit 12 transmits the image file to the external communication device 30 and requests the user to enter a command.

In the preferred embodiment of the present invention, the external communication device 30 is either a portable video phone, a personal digital assistant (PDA), an in-car video communication device, an office video phone or a home video phone. The servo control device 10 is able to be installed in either a dwelling house or an office location. Moreover, the external device 40a or 40b is either any kind of electronic product, a robot or a security device.

Additionally, if the external communication device 30 is disconnected from the internet phone processing unit 12 after operating the external devices 40a and 40b, the internet phone processing unit 12 will send operation information to the external communication device 30 by an e-mail or an SMS (show message service).

Through the above detailed illustration of the overall structural and technical features of the present invention, it can be summarized that the present invention has the following advantages:

1. The status information and the command lists are transmitted in picture files to improve the disadvantage of applying conventional voice way, and the external communication device (such as a cellular phone) is able to monitor and control external devices without installing a particular software or a particular firmware so as to make it more popular.

2. The method of monitoring and controlling a particular device is optionally a wired way or a wireless way so as to make the operations more elastic and diversified.

The present invention introduce strict control method to the external communication device, and the external communication device has to pass the check of both phone number and password before proceeding remote surveillance and monitoring, thus the device for remote surveillance and monitoring is in a high degree of security.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A servo control device for remote surveillance and monitoring, the servo control device at least comprising:
an internet interface processing unit, which is an internet interface provided by a telecommunication carriers/services providers for sending and receiving internet message from and to an external communication device;
an internet phone processing unit, which receives messages from an external communication device through the internet interface processing unit, sends messages to an external communication device, reads telephone messages from an external communication device, and transforms data to either text or image files;
an external device management unit, which receives messages and commands from the internet phone processing unit and sends messages to the internet phone processing unit;
a wireless RF unit, which connects to the external device management unit and receives commands from the external device management unit, controls the status of at least an external device through wireless RF application and sends the status information of the external device back to the external device management unit;
a storage unit, which stores the status information of the external device, connects to the internet phone processing unit; wherein the internet phone processing unit sends a command to the storage unit and the storage unit sends the status of the external device to the internet phone processing unit based on the command received; and
a power unit, which provides electric power to activate the servo control device.

2. The servo control device for remote surveillance and monitoring according to claim 1, wherein the servo control device further comprises an I/O unit, which connects with the external device management unit, receives a command from the external device management unit, controls the status of at least an external device through wire lines and sends the status information of the external device back to the external device management unit.

3. The servo control device for remote surveillance and monitoring according to claim 1, wherein the power unit supplies electric power from a battery, an alternating current (AC) or a universal serial bus (USB).

4. The servo control device for remote surveillance and monitoring according to claim 1, wherein the external communication device is either a portable video phone, a personal digital assistant (PDA), an in-car video communication device, an office video phone or a home video phone.

5. The servo control device for remote surveillance and monitoring according to claim 1, wherein the servo control device is able to be installed in either a dwelling house or an office location.

6. The servo control device for remote surveillance and monitoring according to claim 1, wherein the external device is either a kind of electronic product, a robot or a security device.

7. A control method to a servo control device for remote surveillance and monitoring, wherein the control method further comprising the following steps:
(1) the servo control device receives a telephone message from an external communication device through an internet interface processing unit;
(2) the internet phone processing unit verifies if the telephone message is correct, if YES, the step goes to step (3);
(3) the internet phone processing unit requests the user to input a command from the external communication device;
(4) if the internet phone processing unit receives an inquiry command, the step goes to step (5); if the internet phone processing unit receives a change command, the step goes to step (6);
(5) the internet phone processing unit retrieves the status information of the specific external device from the storage unit, and then the step goes to step (10);
(6) the internet phone processing unit transmits the change command to the external device management unit;
(7) the external device management unit transmits the change command to the wireless RF unit;
(8) the wireless RF unit changes the status of at least an external device based on the change command received;
(9) the status information of the external device after being changed is stored in the storage unit;
(10) the internet phone processing unit transforms the status information of the external device into an image file; and
(11) the internet phone processing unit transmits the image file back to the external communication device.

8. The control method to a servo control device for remote surveillance and monitoring according to claim 7, wherein the step (2) further comprising the following steps:
(2.1) the internet phone processing unit verifies if the telephone message is correct, if YES, the step goes to the next step;
(2.2) the internet phone processing unit requests a password to be inputted from the external communication device; and
(2.3) the internet phone processing unit verifies if the password entered from the external communication device is correct, if YES, the step goes to step (3).

9. The control method to a servo control device for remote surveillance and monitoring according to claim 8, wherein the internet phone processing unit in step (2.1) verifies if the telephone message is correct, if NO, the step is ended.

10. The control method to a servo control device for remote surveillance and monitoring according to claim 8, wherein the internet phone processing unit in step (2.3) verifies if the password entered from the external communication device is correct, if NO, the step is ended.

11. The control method to a servo control device for remote surveillance and monitoring according to claim 7, wherein step (3) further comprising the following steps:
(3.1) the internet phone processing unit retrieves a command list from the storage unit;
(3.2) the internet phone processing unit transforms the command list into an image file; and
(3.3) the internet phone processing unit transmits the image file to the external communication device and requests the user to enter a command.

12. The control method to a servo control device for remote surveillance and monitoring according to claim 7, wherein the external device management unit in step (7) transmits the change command to an I/O unit, and the I/O unit changes the status of at least an external device through wire lines based on the command.

13. The control method to a servo control device for remote surveillance and monitoring according to claim 7, wherein the external communication device is either a portable video phone, a personal digital assistant (PDA), an in-car video communication device, an office video phone or a home video phone.

14. The control method to a servo control device for remote surveillance and monitoring according to claim 7, wherein the servo control device is able to be installed in either a dwelling house or an office location.

15. The control method to a servo control device for remote surveillance and monitoring according to claim 7, wherein the external device is either any kind of electronic product, a robot or a security device.

16. The control method to a servo control device for remote surveillance and monitoring according to claim 7, wherein the internet phone processing unit in step (11) verifies if the external communication device is disconnected, if YES, the internet phone processing unit send operation information to the external communication device by an e-mail or an SMS (show message service).
